(19) United States
(12) Patent Application Publication
(10) Pub. No.: US 2021/0320614 A1
(43) Pub. Date: Oct. 14, 2021

(54) ENERGY-EFFICIENT POWER SUPPLY SYSTEM

(71) Applicant: MING-TSUNG CHEN, Taipei City (TW)

(72) Inventor: MING-TSUNG CHEN, Taipei City (TW)

(21) Appl. No.: 16/846,564

(22) Filed: Apr. 13, 2020

(51) Int. Cl. H02S 10/10; H02S 40/38; H02S 40/34; H02J 1/14; H02J 5/00

(52) U.S. Cl. CPC H02S 10/10; H02S 40/38; H02S 40/34; H02J 2310/16; H02J 5/00; H02J 2300/26; H02J 1/14

(57) ABSTRACT

An energy-efficient power supply system is provided, which includes: a solar electric generating device, an energy storage device, a voltage conversion device, a control device, and a plurality of DC voltage connecting ports. The voltage conversion device provides a DC voltage to the plurality of DC voltage connecting ports. The energy-efficient power supply system does not have any AC voltage connecting port. The energy storage device acquires AC electric power by purchasing from a power grid system via an AC-to-DC voltage converter and a smart electric meter, converts the AC electric power into DC electric power, and stores the DC electric power.

The present disclosure relates to an energy-efficient power supply system, and more particularly to an energy-efficient power supply system capable of reducing energy consumption.

### BACKGROUND OF THE DISCLOSURE

There is a growing trend to install an energy-efficient power supply system in buildings, so as to reduce the use of energy supplied from a power grid system and increase self-sustained power. As solar electric generating devices and thermoelectric converters have been gradually applied in the field of construction, a great deal of energy is wasted during energy transmission and conversion.

Therefore, how an energy-efficient power supply system capable of significantly reducing energy consumption can be provided has become an important subject in the field.

### SUMMARY OF THE DISCLOSURE

In response to the above-referenced technical inadequacies, the present disclosure provides an energy-efficient power supply system. The system includes: a solar electric generating device, providing first electric power; an energy storage device, electrically connected to the solar electric generating device and a power grid system, and storing the first electric power; a voltage conversion device, electrically connected to the solar electric generating device and the energy storage device; a control device, electrically connected to the voltage conversion device, the solar electric generating device, and the energy storage device; and a plurality of DC voltage connecting ports, disposed on different positions in the energy-efficient power supply system and electrically connected to the voltage conversion device, where the voltage conversion device provides a DC voltage to the plurality of DC voltage connecting ports;

the energy-efficient power supply system does not have any AC voltage connecting port; and the energy storage device acquires AC electric power by purchasing from the power grid system via an AC-to-DC voltage converter and a smart electric meter, converts the AC electric power into DC electric power, and stores the DC electric power.

The present disclosure achieves the following advantageous effects. The energy-efficient power supply system of the present disclosure provides only DC voltage connecting ports, effectively reducing energy consumption during conversion of an AC voltage into a DC voltage and further enhancing safety of using electricity.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of an energy-efficient power supply system in an embodiment of the present disclosure;

FIG. 2 is a block diagram of the energy-efficient power supply system in FIG. 1;

FIG. 3 is a block diagram showing a voltage conversion manner of a voltage conversion device of the energy-efficient power supply system in an embodiment of the present disclosure;

FIG. 4 is a block diagram showing another voltage conversion manner of the voltage conversion device of the energy-efficient power supply system in an embodiment of the present disclosure;

FIG. 5 is a schematic view showing purchasing and selling of electric power between a plurality of energy-efficient power supply systems in an embodiment of the present disclosure; and

FIG. 6 is a block diagram showing a communication manner between electronic devices in the energy-efficient power supply system in an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

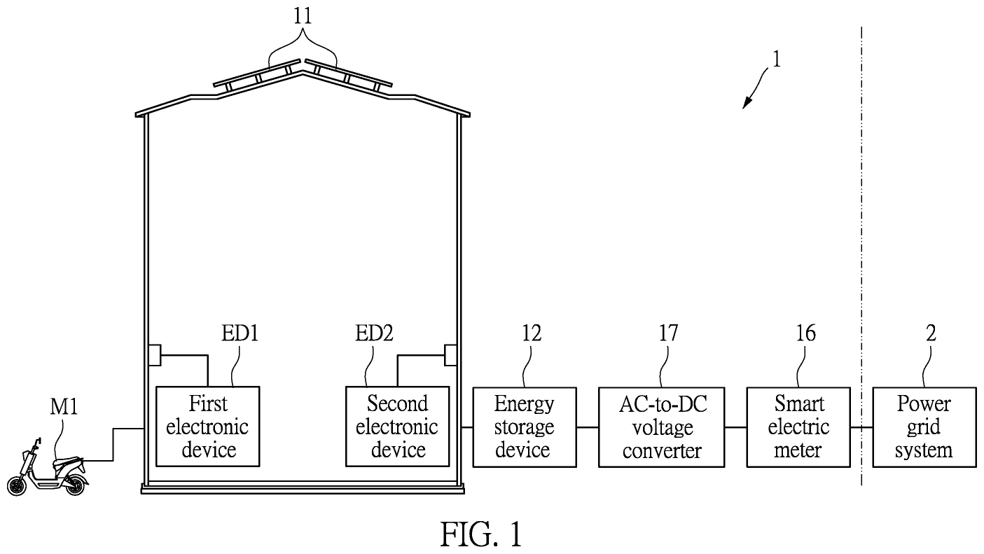

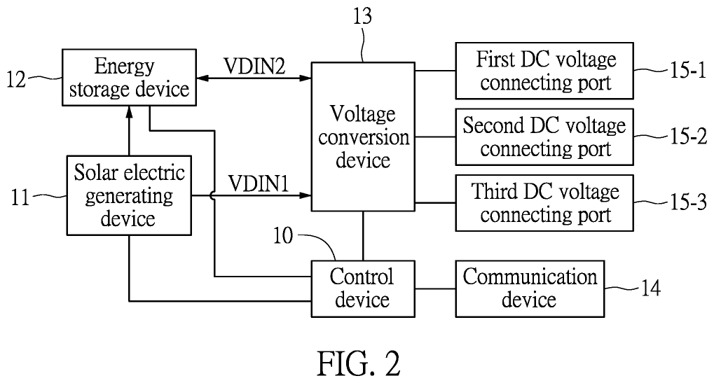

Reference is made to FIG. 1 and FIG. 2, FIG. 1 is a schematic diagram of an energy-efficient power supply system in an embodiment of the present disclosure, and FIG. 2 is a block diagram of the energy-efficient power supply system in FIG. 1.

A zero-energy building refers to a building self-sufficient in electricity. That is, the building includes a power-generating device and an energy storage device to generate and store electric power required by users daily. An ideal status of the energy-efficient power supply system is to have no need to purchase any electric power from a power grid system. However, most of the energy-efficient power supply system still need to purchase a certain amount of electric power from the power grid system to afford daily consumption of the users.

In this embodiment, the energy-efficient power supply system 1 is configured to a building, and includes a control device 10, a solar electric generating device 11, an energy storage device 12, a voltage conversion device 13, a communication device 14, and a plurality of DC voltage connecting ports 15-1 to 15-3. In this embodiment, the energy-efficient power supply system 1 includes a first DC voltage connecting port 15-1, a second DC voltage connecting port 15-2, and a third DC voltage connecting port 15-3. The number of the DC voltage connecting ports may be adjusted as required. The solar electric generating device 11 is disposed outside the building, while the energy storage device 12 is disposed inside or outside the building.

The solar electric generating device 11 is disposed outside the energy-efficient power supply system 1, and is used to receive and convert solar energy into DC electric power. That is, the solar electric generating device 11 provides first electric power to the energy-efficient power supply system 1. The solar electric generating device 11 is electrically connected to the energy storage device 12, the control device 10, and the voltage conversion device 13. The communication device 14 in this embodiment is a wireless or wired communication device.

The energy storage device 12 is electrically connected to the solar electric generating device 11 and the power grid system 2, and is used to store the first electric power generated by the solar electric generating device 11. In addition, the solar electric generating device 11 can also perform voltage stabilization and conversion by using the voltage conversion device 13, and provide a converted voltage to the plurality of DC voltage connecting ports 15-1 to 15-3. The energy storage device 12 is used to store the first electric power of the solar electric generating device 11 and provides second electric power to the voltage conversion device 13.

The voltage conversion device 13 is electrically connected to the solar electric generating device 11, the energy storage device 12, and the control device 10. The voltage conversion device 13 is used to convert the first electric power of the solar electric generating device 11 and the second electric power of the energy storage device 12 into DC electric power, and provide the DC electric power to the plurality of DC voltage connecting ports 15-1 to 15-3.

The control device 10 is electrically connected to the voltage conversion device 13, the solar electric generating device 11, and the energy storage device 12; and is used to control an electric power transmission status between the voltage conversion device 13, the solar electric generating device 11, and the energy storage device 12.

The plurality of DC voltage connecting ports 15-1 to 15-3 are disposed on different positions in the energy-efficient power supply system 1, and is electrically connected to the voltage conversion device 13. The voltage conversion device 13 provides a DC voltage to these DC voltage connecting ports 15-1 to 15-3. The energy-efficient power supply system 1 does not have any AC voltage connecting port.

In this embodiment, the energy-efficient power supply system 1 further includes a smart electric meter 16 and an AC-to-DC voltage converter 17. The smart electric meter 16 is electrically connected to the AC-to-DC voltage converter 17 and the control device 10.

The energy storage device 12 acquires AC electric power by purchasing from the power grid system via the AC-to-DC voltage converter and the smart electric meter, converts the AC electric power into DC electric power, and stores the DC electric power. In this embodiment, the energy storage device 12 functions as a hub connecting the building and the power grid system 2. The building is supplied with only DC power and has no AC power supply.

Specifically, a DC voltage, instead of an AC voltage, is transmitted in the energy-efficient power supply system 1. However, there are several manners of arranging a circuit in the energy-efficient power supply system 1.

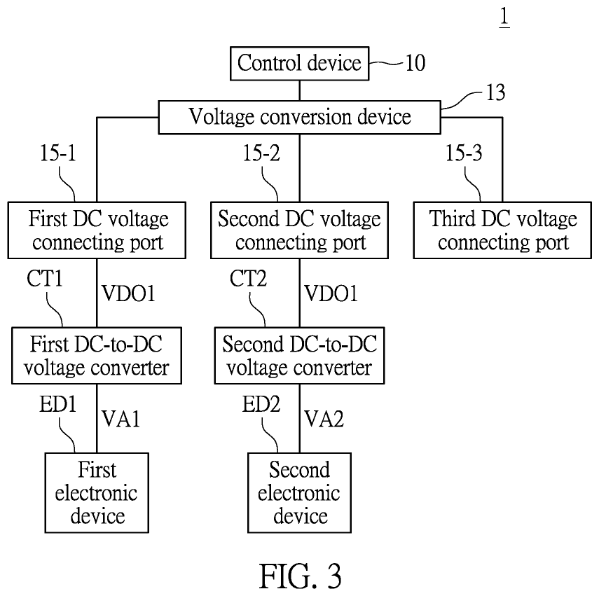

First, reference is made to FIG. 3, which is a block diagram showing a voltage conversion manner of the voltage conversion device of the energy-efficient power supply system in an embodiment of the present disclosure.

The voltage conversion device 13 receives a first DC input voltage VDIN1 of the first electric power provided by the energy storage device 12 and a second DC input voltage VDIN2 of the second electric power provided by the solar electric generating device 11; then converts the first DC input voltage VDIN1 and the second DC input voltage VDIN2 into a first DC output voltage VDO1; and provides the first DC output voltage VDO1 to the plurality of DC voltage connecting ports 15-1 to 15-3.

That is, the first DC voltage connecting port 15-1, the second DC voltage connecting port 15-2, and the third DC voltage connecting port 15-3 in FIG. 3 all provide the first DC output voltage VDO1. In this embodiment, the first DC output voltage VDO1 may have a voltage value of 24V, 48V, 380V or 400V. In other embodiments, the voltage value of the first DC output voltage VDO1 may be adjusted as required. In this embodiment, because the first DC voltage connecting port 15-1, the second DC voltage connecting port 15-2, and the third DC voltage connecting port 15-3 all provide an identical DC voltage, an electronic device to be charged needs to use a DC-to-DC voltage converter for DC voltage conversion to perform voltage conversion, so as to acquire an appropriate supply voltage.

Moreover, a plurality of voltage conversion units (not shown in the figure) in the voltage conversion device 13 in this embodiment is designed in a modular form. A user may use a parallel connection manner to design an electrical system required to provide an identical voltage but allow a large current. For example, the energy-efficient power supply system 1 provides a high-voltage large-current charging mode to an electric motorcycle Ml.

Upon electrical connection to one of the DC voltage connecting ports 15-1 to 15-3, a first electronic device ED1 uses a first DC-to-DC voltage converter CT1 to establish the electrical connection to the DC voltage connecting port, and the first DC-to-DC voltage converter CT1 converts the first DC output voltage VDO1 into a first supply voltage VA1 for the first electronic device ED1.

Upon electrical connection to one of the DC voltage connecting ports 15-1 to 15-3, a second electronic device ED2 uses a second DC-to-DC voltage converter CT2 to establish the electrical connection to the DC voltage connecting port, and the second DC-to-DC voltage converter CT2 converts the first DC output voltage VDO1 into a second supply voltage VA2 for the second electronic device ED2.

That is, the first electronic device ED1 can acquire the required first supply voltage VA1 via the first DC-to-DC voltage converter CT1 and the second electronic device ED2 can acquire the required second supply voltage VA2 via the second DC-to-DC voltage converter CT2. In this embodiment, the first supply voltage VA1 is unequal to the second supply voltage VA2, while in other embodiments, they may be equal.

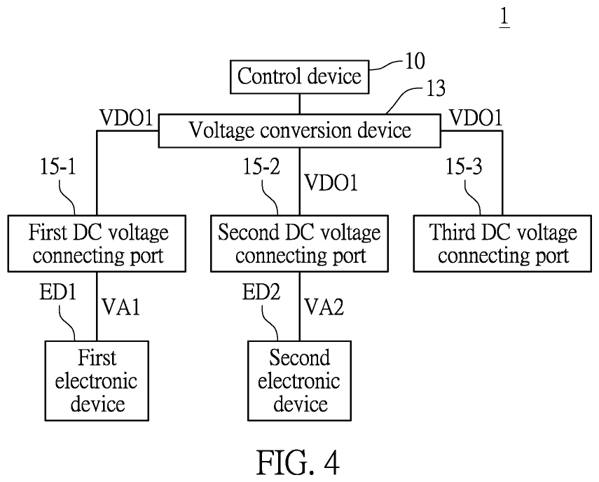

Reference is made to FIG. 4, which is a block diagram showing another voltage conversion manner of the voltage conversion device of the energy-efficient power supply system in an embodiment of the present disclosure.

When the first electronic device ED1 and the second electronic device ED2 are electrically connected to two of the DC voltage connecting ports 15-1 to 15-3, the control device 10 controls the voltage conversion device 13 to provide the required first supply voltage VA1 and second supply voltage VA2 respectively to the first electronic device ED1 and the second electronic device ED2. Specifically, in FIG. 4, the control device 10 and the voltage conversion device 13 may be communicatively connected to the first electronic device ED1 and the second electronic device ED2, to determine a voltage separately required by the first electronic device ED1 and the second electronic device ED2. The control device 10 then controls the voltage conversion units (not shown in the figure) of the voltage conversion device 13 to provide the first supply voltage VA1 and the second supply voltage VA2 respectively to the first electronic device ED1 and the second electronic device ED2. That is, the first electronic device ED1 and the second electronic device ED2 only need to be electrically connected to the DC voltage connecting ports 15-1 to 15-3, and then the control device 10 controls the voltage conversion device 13 to provide a corresponding voltage to the corresponding electronic device, without the need to additionally dispose a DC-to-DC voltage converter for voltage conversion.

In this embodiment, the plurality of voltage conversion units (not shown in the figure) of the voltage conversion device 13 may provide a DC voltage, for example, DC12V to DC400V, within a preset voltage output range. The energy storage device is a lithium-ion battery or a lithium manganese battery.

Moreover, the plurality of voltage conversion units (not shown in the figure) of the voltage conversion device 13 are electrically connected to at least one DC voltage connecting port.

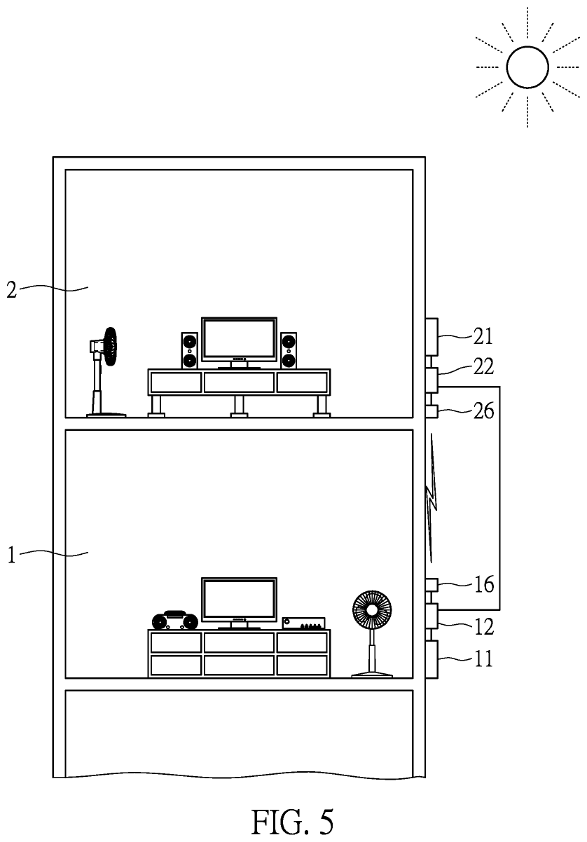

Reference is made to FIG. 5, which is a schematic view showing purchasing and selling of electric power between a plurality of energy-efficient power supply systems in an embodiment of the present disclosure.

The energy-efficient power supply system 1 and an energy-efficient power supply system 2 are on different floors in the same building.

The energy-efficient power supply system 1 is electrically connected to a smart electric meter 26 of the second energy-efficient power supply system 2 via the smart electric meter 16. Purchasing and selling of DC electric power may be carried out between the smart electric meters 16 and 26, that is, the smart electric meters 16 and 26 may control the second electric power in their respective energy storage devices. Moreover, the energy storage device 12 of the energy-efficient power supply system 1 is spaced apart from an energy storage device 22 of the energy-efficient power supply system 2 by a distance less than a preset value. The control over the distance between the energy storage devices 12 and 22 aims to reduce attenuation and consumption of the DC electric power in long-distance transmission. The electric power generated by a solar electric generating device 21 of the energy-efficient power supply system 2 is also stored in the energy storage device 22.

Firstly, the smart electric meters 16 and 26 may sell the second electric power in their respective energy storage devices. It is assumed that a remaining electric capacity in the energy storage device 12 is less than a first critical value, and the first electric power in the solar electric generating device 11 is 0 during nighttime; at this time, the smart electric meter 16 sends a purchasing signal to surrounding smart electric meters. Afterwards, the smart electric meter 26 of the energy-efficient power supply system 2 receives the purchasing signal and determines that the energy storage device 22 has sufficient electric power to use by the user and to sell. Lastly, the smart electric meter 26 sends an acknowledgement signal to the smart electric meter 16 to sell a certain amount of electric power.

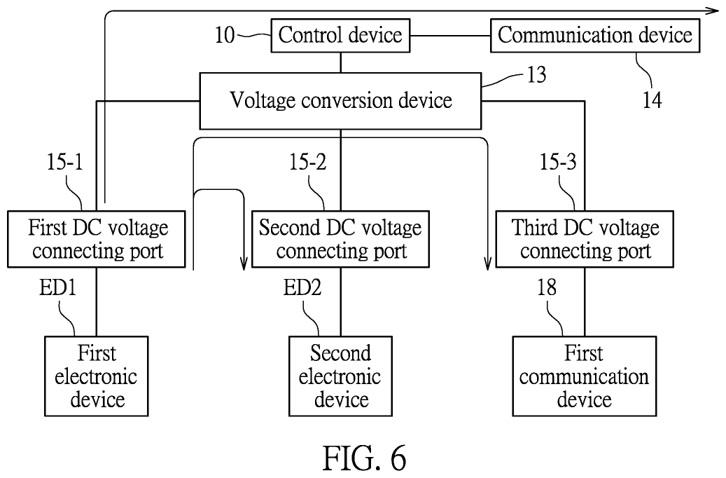

Reference is made to FIG. 6, which is a block diagram showing a communication mariner between electronic devices in the energy-efficient power supply system in an embodiment of the present disclosure.

A wired communication path exists between the control device 10, the voltage conversion device 13, and the plurality of DC voltage connecting ports 15-1 to 15-3.

Upon electrical connection to one of the DC voltage connecting ports 15-1 to 15-3, the first electronic device ED1 performs data transmission via the control device 10 and the communication device 14 through one of the DC voltage connecting ports 15-1 to 15-3.

When a wireless communication device 18 and the first electronic device ED1 are electrically connected to two of the DC voltage connecting ports 15-1 to 15-3, the wireless communication device 18 is communicatively connected to the control device 10, and the first electronic device ED1 can perform data transmission via the control device 10 and the wireless communication device 18. In this embodiment, the wireless communication device 18 is a Wi-Fi communication device, Bluetooth® communication device, Sigfox communication device, LoRa communication device, 4G communication device, 5G communication device, or NB-IoT communication device.

Upon electrical connection to two of the DC voltage connecting ports 15-1 to 15-3, the first electronic device ED1 and the second electronic device ED2 are communicatively connected to the control device 10, and perform data transmission via the control device 10.

That is, provided that the electronic devices are connected to the DC voltage connecting ports 15-1 to 15-3, communicative connection can be established therebetween. Moreover, communicative connection to an external network can also be established via different communication devices. The present disclosure achieves the following advantageous effects. The energy-efficient power supply system of the present disclosure provides only DC voltage connecting ports, effectively reducing energy consumption during conversion of an AC voltage into a DC voltage and further enhancing safety of using electricity. The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An energy-efficient power supply system, applied in a building, and comprising:
a solar electric generating device disposed outside the building, providing first electric power;
an energy storage device electrically connected to the solar electric generating device and a power grid system, and storing the first electric power;
a voltage conversion device electrically connected to the solar electric generating device and the energy storage device;
a control device electrically connected to the voltage conversion device, the solar electric generating device, and the energy storage device; and
a plurality of direct current (DC) voltage connecting ports disposed on different positions in the energy-efficient power supply system and electrically connected to the voltage conversion device;
wherein the voltage conversion device provides a DC voltage to the plurality of DC voltage connecting ports;
wherein the energy storage device acquires alternating current (AC) electric power by purchasing from the power grid system via an AC-to-DC voltage converter and a smart electric meter, converts the AC electric power into DC electric power, and stores the DC electric power.

2. The energy-efficient power supply system of claim 1, wherein the voltage conversion device receives a first DC input voltage provided by the energy storage device and a second DC input voltage provided by the solar electric generating device; converts the first DC input voltage or the second DC input voltage into a first DC output voltage; and provides the first DC output voltage to the plurality of DC voltage connecting ports.

3. The energy-efficient power supply system of claim 1, further comprising a first communication device electrically connected to the control device.

4. The energy-efficient power supply system of claim 1, wherein upon electrical connection to one of the plurality of DC voltage connecting ports, a first electronic device uses a first DC-to-DC voltage converter to establish the electrical connection to the DC voltage connecting port, and the first DC-to-DC voltage converter converts the first DC output voltage into a first supply voltage for the first electronic device; and
upon electrical connection to one of the plurality of DC voltage connecting ports, a second electronic device uses a second DC-to-DC voltage converter to establish the electrical connection to the DC voltage connecting port, and the second DC-to-DC voltage converter converts the first DC output voltage into a second supply voltage for the second electronic device.

5. The energy-efficient power supply system of claim 1, wherein when the first electronic device and the second electronic device are electrically connected to two of the plurality of DC voltage connecting ports, the control device controls the voltage conversion device to provide a required first supply voltage and a required second supply voltage to the first electronic device and the second electronic device, respectively.

6. The energy-efficient power supply system of claim 5, wherein the voltage conversion device comprises a plurality of voltage conversion units which are electrically connected to the plurality of DC voltage connecting ports.

7. The energy-efficient power supply system of claim 1, wherein the energy-efficient power supply system is communicatively connected to another smart electric meter of another energy-efficient power supply system via the smart electric meter, and carries out purchasing or selling of DC electric power; and the energy storage device of the energy-efficient power supply system is spaced apart from another energy storage device of the another energy-efficient power supply system by a distance less than a preset value.

8. The energy-efficient power supply system of claim 3, wherein a wired communication path exists between the control device, the voltage conversion device, and the plurality of DC voltage connecting ports; and
upon electrical connection to one of the DC voltage connecting ports, the first electronic device performs data transmission via the control device and the communication device through one of the DC voltage connecting ports.

9. The energy-efficient power supply system of claim 1, wherein when a wireless communication device and the first electronic device are electrically connected to two of the DC voltage connecting ports, the wireless communication device is communicatively connected to the control device, and the first electronic device is able to perform data transmission via the control device and the wireless communication device.

10. The energy-efficient power supply system of claim 1, wherein upon electrical connection to two of the DC voltage connecting ports, the first electronic device and the second electronic device are communicatively connected to the control device, and perform data transmission via the control device.
